(19) United States
(12) Patent Application Publication
(10) Pub. No.: US 2021/0009824 A1
(43) Pub. Date: Jan. 14, 2021

(54) INK, INK ACCOMMODATING CONTAINER, RECORDING DEVICE, RECORDING METHOD, AND RECORDED MATTER

(71) Applicants: Ryo MIYAKOSHI, Kanagawa (JP); Chikako HATTA, Kanagawa (JP)

(72) Inventors: Ryo MIYAKOSHI, Kanagawa (JP); Chikako HATTA, Kanagawa (JP)

(21) Appl. No.: 16/921,989

(22) Filed: Jul. 7, 2020

(30) Foreign Application Priority Data
Jul. 11, 2019 (JP) 2019-129038

(51) Int. Cl. C09D 11/102; B41J 2/175; B41M 5/00

(52) U.S. Cl. CPC C09D 11/102; B41M 5/0023; B41J 2/17503

(57) ABSTRACT

An ink includes a coloring material, a crystalline polyester urethane resin, and a non-crystalline polyurethane resin, wherein dry matter of the ink has a differential scanning calorimetry curve having a melting peak temperature (Tm) of from 30 to 100 degrees C. as measured with a differential scanning calorimeter.

### CROSS-REFERENCE TO RELATED APPLICATIONS

This patent application is based on and claims priority pursuant to 35 U.S.C. § 119 to Japanese Patent Application No. 2019-129038, filed on Jul. 11, 2019, in the Japan Patent Office, the entire disclosures of which are hereby incorporated by reference herein.

### BACKGROUND

### Technical Field

The present disclosure relates to an ink, an ink accommodating container, a recording device, a recording method, and recorded matter.

### Description of the Related Art

Since inkjet recording devices are relatively quiet, have low running costs, and are capable of printing color images with ease, they are now widely used at home to output digital information.

Inkjet technologies have been appealing in commercial and industrial use in addition to home use.

Because coated paper having low ink absorbency and non-ink-absorbing plastic media are used as recording media in commercial and industrial settings, the image quality comparable with that of typical offset printing is needed for inkjet printing on such media.

These media minimally absorb ink, and images formed with the ink are not readily fixed on the media.

In general, a resin should be added to ink to enhance the fixability of images on such recording media.

### SUMMARY

According to embodiments of the present disclosure, an ink is provided which includes a coloring material, a crystalline polyester urethane resin, and a non-crystalline polyurethane resin, wherein dry matter of the ink has a differential scanning calorimetry curve having a melting peak temperature (Tm) of from 30 to 100 degrees C. as measured with a differential scanning calorimeter.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating a perspective view of an example of a recording device; and

FIG. 2 is a diagram illustrating a perspective view of an example of a tank of a recording device.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

Ink containing a crystalline polyester resin has been proposed in JP-2014-2016223-A1 and JP-2017-218523-A1.

When ink containing a resin is used to enhance the fixability, storage stability of the ink deteriorates and discharging stability is not sufficiently regained when the ink is supplied to nozzles of an inkjet head after the inkjet head is left uncapped with a protection cap to keep the ink from drying.

The ink of the present disclosure enhances fixability between a recording medium and an image formed thereon with an ink and improves storage stability and discharging recovery.

Next, aspects of embodiments of the present disclosure are described.

Ink

The ink of the present embodiment includes a coloring material and a resin, and may furthermore optionally include components such as water, an organic solvent, and a surfactant.

Resin

The ink of the present embodiment contains a crystalline polyester urethane resin as a polyester urethane resin having crystallinity, a non-crystalline polyurethane resin as a polyurethane resin having no crystallinity, and other optional resins. The other optional resins are not particularly limited and can be suitably selected to suit to a particular application. Examples include, but are not limited to, polyester-based resins, acrylic-based resins, vinyl acetate-based resins, styrene-based resins, butadiene-based resins, styrene-butadiene-based resins, vinylchloride-based resins, acrylic styrene-based resins, and acrylic silicone-based resins. These can be used alone or in combination.

Crystalline polyester urethane resins are formed by linking crystalline polyesters with a urethane bond and thus have high resistance to organic solvents and other substances contained in the ink.

For this reason, the ink achieves excellent storage stability even if the ink containing the resin or resins as resin particles is stored in a high temperature environment.

When the ink applied dries on heating, the crystalline portion of the resin temporarily melts or softens, which lowers the viscosity of the ink so that the ink contacts the recording medium over a wider area. The ink thus forms a stiff film when the crystalline portion recrystallizes and the image fixability improves as a result.

Inclusion of the non-crystalline polyurethane resin in ink helps to form a sea-island structure that includes fine crystal domains of crystalline polyester urethane resin as islands. This sea-island structure reduces agglomeration of the crystal domains, thereby enhancing the storage stability and discharging recovery of the ink.

The mass ratio of the crystalline polyester urethane resin to the non-crystalline polyurethane resin is preferably from 15:85 to 85:15 and more preferably from 20:80 to 80:20.

When the mass ratio is 15:85 or greater, the viscosity of ink decreases when resins melt and fixability at low temperatures increases.

In addition, the static storage stability of the ink improves because crystallization enhances strength. This is because the resin particles soften and the viscosity of the ink increases during storage if the resin is weak so that the viscosity of the resin deteriorates over time and the ink softens as a result. To the contrary, if a resin is strong, the resin and the ink keep their viscosity.

The acid values of the crystalline polyester urethane resin and the non-crystalline polyurethane resin are preferably from 10 to 40 mgKOH/g. A resin having an acid value of 10 or greater mgKOH/g improves dispersion stability thereof, thereby enhancing dispersion stability and discharging recovery. When the acid value is 40 mgKOH/g or less, a film having excellent mechanical strength is formed. Also, hydrophilicity of the resin is appropriate, so that water resistance is improved and the resin contained in the ink in a form of resin particle is suitably stabilized.

The acid value of a resin is calculated from the carboxyl group concentration in raw materials for the resin when the resin is prepared or measured by titrating a tetrahydrofuran (THF) solution containing the resin with 0.1M potassium hydroxide methanol solution.

When the carboxyl group in a resin is neutralized, an excess amount of hydrochloric acid aqueous solution is added to prepare an acid solution followed by extracting the resin with chloroform. The extracted resin is heated or dried under a reduced pressure and dissolved in THF followed by titrating with 0.1M potassium hydroxide methanol solution to measure the acid value of the resin.

The crystalline polyester urethane resin and the non-crystalline polyurethane resin are preferably resin emulsions. The resin emulsion refers to a state in which resin particles are dispersed in water and ink. It does not matter whether the resin particle is solid or liquid.

Examples of a method of dispersing resin particles containing such resins in water or ink include, but are not limited to, a forced emulsification method using a dispersant and a self-emulsification method using a resin having an anionic group. A dispersant may remain in an image formed with ink in the forced emulsification method, thereby degrading the strength of the image. Therefore, using the self-emulsification method is preferable.

Specific examples of the anionic group include, but are not limited to, a carboxyl group, carboxylate group, sulfonic acid group, and sulfonate group. Of these, it is preferable to use a carboxylate group or sulfonate group all or part, and in particular all of which is neutralized by a substance such as a basic compound.

Specific examples of neutralizing agents usable for neutralizing anionic groups include, but are not limited to, organic amines such as ammonium, triethylamine, pyridine, and morpholine, basic compounds such as alkanolamines such as monoethanol amine, and metal base compounds containing metal such as Na, K, Li, and Ca.

The cumulative volume particle diameter of the crystalline polyester urethane resin and the non-crystalline polyurethane resin is not particularly limited and can be suitably selected to suit to a particular application. The cumulative volume particle diameter (D50) is preferably from 10 to 1,000 nm, more preferably from 10 to 200 nm, furthermore preferably from 10 to 100 nm, and preferably from 10 to 50 nm to obtain good fixability and image hardness. The cumulative volume particle diameter can be measured by using an instrument such as a particle size analyzer (Nanotrac Wave-UT151, manufactured by MicrotracBEL Corp.).

The total amount of the crystalline polyester urethane resin and the non-crystalline polyurethane resin is not particularly limited and can be suitably selected to suit to a particular application. In terms of fixability and storage stability of the ink, the proportion thereof in the ink is preferably from 1 to 30 percent by mass and more preferably from 5 to 20 percent by mass of the total amount of the ink.

Crystalline Polyester Urethane Resin

The crystalline polyester urethane resin contains a polyester having a crystalline portion as structural unit and may optionally contain other structural units. “Structural unit” refers to a partial structure in a polymer derived from a material for use in polymerization of a resin. The crystalline polyester urethane resin represents a polyester urethane resin having an endothermic peak as measured using a differential scanning calorimeter.

The melting peak temperatures of dry matter of ink and the melting peak temperature of dry matter of a liquid dispersion of the crystalline polyester urethane resin are described below.

Melting Peak Temperature (Tm) of Dry Matter of Ink

The dry matter of ink of the present embodiment has an endothermic peak in the differential scanning calorimetry (DSC) curve obtained under the measuring conditions below using a differential scanning calorimeter. Specifically, it has a melting peak temperature (Tm) (hereinafter referred to as melting point) from 30 to 100 degrees C. in the second temperature rising. The melting point is preferably the endothermic peak corresponding to a crystalline polyester urethane resin. When the melting point is 30 or higher degrees C., it is possible to form an image having excellent mechanical strength. When the melting point is 100 degrees C. or lower, attachment between resins and resins and a recording medium attributable to heat drying becomes strong, thereby enhancing fixability and blocking resistance.

Measuring Conditions 1

A total of 4 g of ink was placed in a vessel such that the ink uniformly spreads. Next, the ink is dried at 70 degrees C. for one hour and at 130 degrees C. for one hour to prepare dry matter of the measuring sample. Thereafter, the measuring sample is analyzed using a differential scanning calorimeter (Q2000, manufacture by TA Instruments) under the following conditions to determine its thermal properties. A DSC curve, which is a graph of heat of reaction and temperature, is plotted from the measuring results and the temperature at the top of the melting (endothermic) peak present during the second temperature rising is defined as the melting point.
Sample container: Aluminum sample pan (with a lid)
Quantity of sample: 5 mg
Reference: Aluminum sample pan (empty container)
Atmosphere: nitrogen (flow amount: 50 mL/min)
Starting Temperature: −80 degrees C.
Rate of temperature rising: 10 degrees C./min
Ending temperature: 130 degrees C.
Holding time: one minute
Rate of temperature falling: 10 degrees C./min
Ending temperature: −80 degrees C.
Holding time: five minutes
Rate of temperature rising: 10 degrees C./min
Ending temperature: 130 degrees C.

In the DSC curve, the heat of melting at the endothermic peak is preferably from 0.5 to 30.0 J/g and more preferably from 1.0 to 20.0 J/g. When the heat of melting is 0.5 J/g or greater, the degree of crystallinity at the crystalline portion is increased, so that viscosity sufficiently lowers during the heat drying, thereby enhancing attachability of an image. When the heat of melting is 30 J/g or less, the proportion of the crystalline portion in a resin is not excessively high, which enhances storage stability and discharging recovery.

The crystallization peak temperature in the DSC curve is preferably from −30 to 80 degrees C. and the crystallization heat of reaction at the crystallization peak is preferably from 1.0 to 12.0 J/g.

Melting Peak Temperature of Dry Matter of Liquid Resin Dispersion

The dry matter of liquid resin dispersion of the crystalline polyester urethane resin has an endothermic peak in the DSC curve obtained under the measuring conditions 2 below using a DSC and preferably has a melting point of from 40 to 100 degrees C. in the second temperature rising. When the melting point is 40 degrees C. or higher, storage stability and discharging recovery of the ink improve. When the melting point is 100 degrees C. or lower, attachment between resins and resins and a recording medium attributable to heat drying becomes strong, thereby enhancing fixability.

Measuring Conditions 2

A total of 4 g of liquid aqueous dispersion containing a crystalline polyester urethane resin or liquid aqueous dispersion containing a crystalline polyester urethane resin isolated from ink containing the crystalline polyester urethane resin was placed in a vessel such that the liquid aqueous dispersion uniformly spreads. Next, the ink is dried at 70 degrees C. for one hour and further at 130 degrees C. for one hour to prepare dry matter of the measuring sample. Thereafter, the measuring sample is analyzed using a differential scanning calorimeter (Q2000, manufacture by TA Instruments) under the following conditions to determine its thermal properties. A DSC curve, which is a graph of heat of reaction and temperature, is plotted from the measuring results and the temperature at the top of the melting (endothermic) peak present during the second temperature rising is defined as the melting point.
Sample container: Aluminum sample pan (with a lid)
Quantity of sample: 5 mg
Reference: Aluminum sample pan (empty container)
Atmosphere: nitrogen (flow amount: 50 mL/min)
Starting Temperature: −80 degrees C.
Rate of temperature rising: 10 degrees C./min
Ending temperature: 130 degrees C.
Holding time: one minute
Rate of temperature falling: 10 degrees C./min
Ending temperature: −80 degrees C.
Holding time: five minutes
Rate of temperature rising: 10 degrees C./min
Ending temperature: 130 degrees C.

The heat of melting at the endothermic peak in the DSC curve is preferably from 5 to 100 J/g, more preferably from 10 to 80 J/g, and furthermore preferably from 20 to 50 J/g. When the heat of melting is 5 J/g or greater, the degree of crystallinity at the crystalline portion is increased, thereby sufficiently lowers viscosity during the heat drying, which enhances attachability of an image. When the heat of melting is 100 or lower J/g, the proportion of the crystalline portion in a resin is not excessively high, which enhances storage stability, discharging stability, and image strength.

The crystallization peak temperature in the DSC curve is preferably from −30 to 80 degrees C. and the crystallization heat of reaction at the crystallization peak is preferably from 5 to 100.0 J/g.

Non-Crystalline Polyurethane Resin

The non-crystalline polyurethane resin is a polyurethane resin having no crystallinity and preferably has a structural unit derived from a non-crystalline polymer polyol and other optional structural units.

The glass transition temperature Tg of the non-crystalline polyurethane resin is preferably from −40 to 100 degrees C., more preferably from 0 to 90 degrees C., and furthermore preferably from 40 to 80 degrees C. Images having excellent blocking resistance can be formed with ink containing a non-crystalline polyurethane resin having a Tg in this range.

Method of Manufacturing Crystalline Polyester Urethane Resin and Non-crystalline Polyurethane Resin

One way to manufacture a crystalline urethane resin and a non-crystalline polyurethane resin is as follows.

First, a polymer polyol (A), a short-chain polyhydric alcohol (B), a polyhydric alcohol (C) having an anionic group, and a polyisocyanate (D) are allowed to react in the absence of a solvent or the presence of an organic solvent to manufacture an isocyanate-terminated urethane prepolymer. When a crystalline polyester urethane resin is manufactured, crystalline polyester polyol (A1) is used as the polymer polyol (A). When a non-crystalline polyurethane resin is manufactured, non-crystalline polymer polyol (A2) is used as the polymer polyol (A).

Next, the anionic group in the urethane prepolymer having an isocyanate group at a terminal is optionally neutralized by a neutralizer. Water is then added to disperse the neutralized urethane prepolymer. The system is optionally purged of the organic solvent to obtain the crystalline polyester urethane resin. A di- or higher valent polyamine (hereinafter referred to as polyamine) is optionally added before the system is purged of the organic solvent, thereby elongating or cross-linking a crystalline polyester urethane resin by a urea bond formed of an isocyanate group at terminal and a polyvalent amine.

Specific examples of the usable organic solvent during the reaction include, but are not limited to, ketones such as acetone and methylethyl ketone, ethers such as tetrahydrofuran and dioxane, acetic acid esters such as ethyl acetate and butylacetate, nitriles such as acetonitrile, and amides such as dimethyl formamide, N-methyl pyrrolidone, and 1-ethyl-2-pyrrolidone. These can be used alone or in combination.

The composition ratio of each material for use in the reaction is that [moles of (C)/(moles of (A)+moles of (B)+moles of (C))] is preferably from 0.15 to 0.5, more preferably from 0.2 to 0.5, and furthermore preferably from 0.25 to 0.4.

When the composition ratio is 0.5 or less, excessive hydrophilicity prevents an ink film from being significantly brittle, so that degradation of water resistance of images is prevented. Further, it is possible to prevent ink from being thickened attributable to excessive miniaturization of resin particles. Conversely, when the composition ratio is 0.15 or more, the dispersion stability of resin particles is improved.

The composition ratio of each material for use in the reaction is that [equivalent number of (D)/(equivalent number of (A)+equivalent number of (B)+equivalent number of (C))] is preferably from 1.05 to 1.6, more preferably from 1.05 to 1.5, and furthermore preferably from 1.1 to 1.35.

A film achieves excellent mechanical strength when the composition ratio is in this range so that images have excellent blocking resistance and scratch resistance. Polymer Polyol(A)

As the polymer polyol, the crystalline polyester urethane resin (A1) for use in manufacturing a crystalline polyester urethane resin and the non-crystalline polymer polyol (A2) for use in manufacturing a non-crystalline polyurethane resin are described.

Crystalline Polyester Polyol (A1)

The crystalline polyester polymer preferably has a hydroxyl value (OHV) of from 20 to 200 mgKOH/g, more preferably from 50 to 150 mgKOH/g, and even more preferably from 70 to 120 mgKOH/g.

When the hydroxyl value is within this range, the resin has good dispersion stability and demonstrates appropriate crystallinity, thereby obtaining a crystalline polyester urethane resin with which an image having excellent fixability is formed.

The type of the crystalline polymer polyol is not particularly limited and can be suitably selected to suit to a particular application. Aliphatic polyester polymers have high crystallinity, which is preferable.

The molecular weight of the crystalline polyester polyol is not particularly limited and can be suitably selected to suit to a particular application. The weight average molecular weight (Mw) is preferably from 2,000 to 20,000, more preferably from 3,000 to 15,000, furthermore preferably from 3,000 to 10,000, and particularly preferably from 3,000 to 5,000 in GPC measuring.

When the weight average molecular weight is within this range, the resin has good dispersion stability and demonstrates appropriate crystallinity, so that a crystalline polyester urethane resin emulsion is obtained with which images having excellent fixability can be produced.

The number average molecular weight (Mn) of the crystalline polyester polyol is preferably from 1,000 to 4,000 and more preferably from 2,000 to 3,000.

The Tm of the crystalline polyester polyol is not particularly limited and can be suitably selected to suit to a particular application. It is preferably from 50 to 100 degrees C. The melting point is determined based on the endothermic peak value in the DSC curve in differential scanning calorimetry measuring. The crystallinity and molecular structure of the crystalline polyester can be determined by existing technologies such as NMR measuring, differential scanning calorimeter (DSC) measuring, X-ray diffraction measuring, gas chromotography/mass spectrometer (GC/MS) measuring, liquid chromatography/mass spectrometry (LC/MS) measuring, and infrared absorption (IR) spectrum measuring.

Next, one way of manufacturing a crystalline polyester polyol will be described. The crystalline polyester polyol is preferably manufactured by polycondensation of polyvalent polyol and polyvalent carboxylic acid in the absence of a solvent or the presence of an organic solvent. That is, the crystalline portion of the crystalline polyester urethane resin is derived from a polyhydric alcohol and a polyvalent carboxylic acid for use in the production of the crystalline polyester polyol.

Polyhydric Alcohol

The polyhydric alcohol is not particular limited and can be suitably selected to suit to a particular application. Examples include, but are not limited to, diol and tri- or higher alcohols.

Aliphatic diols are preferable and saturated aliphatic diols are more preferable as diol.

Examples of the saturated aliphatic diol include, but are not limited to, linear saturated aliphatic diols and branched saturated aliphatic diols. Of these, straight-chain saturated aliphatic diols are preferable, and straight-chain saturated aliphatic diols having 2 to 12 carbon atoms are more preferable. When the saturated aliphatic diol is linear, crystallinity of the crystalline polyester does not lower and the melting point does not easily lower. The number of carbon atoms of the saturated aliphatic diol is preferably 12 or less because it becomes easier to obtain a material.

Specific examples of the saturated aliphatic diol include, but are not limited to, ethylene glycol, 1,3-propanediol, 1,4-butanediol, 1,5-pentanediol, 1,6-hexanediol, 1,7-heptanediol, 1,8 -octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosandecanediol. These can be used alone or in combination.

Specific examples of the alcohols having three or more hydroxyl groups include, but are not limited to, glycerin, trimethylol ethane, trimethylol propane, and pentaerythritol. These can be used alone or in combination.

Polyvalent Carboxylic Acid

The polyvalent carboxylic acids are not particularly limited and can be suitably selected to suit to a particular application. Examples include, but are not limited to, divalent carboxylic acids and trivalent or higher carboxylic acids. Aliphatic dicarboxylic acids are preferable.

Specific examples of the dicarboxylic acids include, but are not limited to, saturated aliphatic dicarboxylic acids such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid; aromatic dicarboxylic acids such as phthalic acid, isophthalic acid, terephthalic acid, naphthalene-2,6-dicarboxylic acid, malonic acid, and mesaconic acid; and anhydrides or lower alkylesters (1 to 3 carbon atomes) thereof. These can be used alone or in combination.

Specific examples of the tri-or higher carboxylic acids include, but are not limited to, 1,2,4-benzene tricarboxylic acid, 1,2,5-benzene tricarboxylic acid, 1,2,4-naphtalene tricarboxylic acid, and their anhydrides or lower alkyl esters (1 to 3 carbon atoms). These can be used alone or in combination.

The polyvalent carboxylic acid may optionally contain a dicarboxylic acid having a sulfonic acid group and a dicarboxylic acid having a double bond in addition to the saturated aliphatic dicarboxylic acid and the aromatic dicarboxylic acid.

Non-Crystalline Polymer Polyol (A2)

The non-crystalline polymer polyol is not particularly limited. Examples include, but are not limited to, polycarbonate-based polymer polyol, polyether-based polymer polyol, polyester-based polymer polyol, and polycarbonate-based polymer polyol. These can be used alone or in combination.

The Tg of the non-crystalline polymer polyol is preferably from −100 to 100 degrees C., more preferably from −40 to 90 degrees C., and furthermore preferably from 40 to 80 degrees C. Images having excellent blocking resistance can be formed with ink containing a non-crystalline polyurethane resin having a Tg in this range.

The non-crystalline polymer polyol preferably has a hydroxyl value (OHV) of from 20 to 200 mgKOH/g, more preferably from 50 to 150 mgKOH/g, and even more preferably from 70 to 120 mgKOH/g. Dispersion stability of a resin improves when the OHV is in the above range.

The molecular weight of the non-crystalline polymer polyol is not particularly limited and can be suitably selected to suit to a particular application. The weight average molecular weight (Mw) is preferably from 2,000 to 20,000, more preferably from 3,000 to 15,000, furthermore preferably from 3,000 to 10,000, and particularly preferably from 3,000 to 5,000 in GPC measuring.

When the Mw is in the above-range, urethane resin particles having excellent chemical resistance can be produced. Also, the urethane resin particles have suitable Tg to achieve good friction resistance and low temperature fixability.

The Mn of the non-crystalline polymer polyol is preferably from 1,000 to 4,000 and more preferably from 2,000 to 3,000.

Short-chain Polyhydric Alcohol (B)

Specific examples of the short-chain polyhydric alcohol include, but are not limited to, polyhydric alcohols having 2 to 15 carbon atoms such as ethylene glycol, propylene glycol, 1,4-butanediol, 1,5-pentanediol, neopentyl glycol, 1,6-hexanediol, 1,8-octanediol, 1,4-cyclohexane dimethanol, diethylene glycol, glycerin, and trimethylolpropane.

Polyhydric Alcohol (C) Having Anionic Group

The polyhydric alcohol having an anionic group is not particularly limited. It is possible to use materials having two or more hydroxyl groups and a functional group such as carboxylic acid or sulfonic acid as the anionic group.

Specific examples include, but are not limited to, carboxylic acid groups such as dimethylolpropionic acid, dimethylolbutanoic acid, dimethylolbutyric acid, dimethylolvaleric acid, trimethylolpropanoic acid and trimethylolbutanoic acid and a sulfonic acid such as 1,4-butanediol-2-sulfonic acid.

Polyisocyanate (D)

There is no specific limitation to the polyisocyanate mentioned above.

Specific examples include, but are not limited to, aromatic polyisocyante compounds such as 1,3-phenylene diisocyanate, 1,4-phenylene diisocyanate, 2,4-tolylene diisocyanate (TDI), 2,6-tolylene diisocyanate, 4,4′-diphenyl methane diisocyanate (MDI), 2,4-diphenyl methane diisocyanate, 4,4′-diisocynato biphenyl, 3,3′-dimethyl-4,4′-diisocyanate biphenyl, 3,3′-dimethyl-4,4′-diisocyanate diphenyl methane, 1, 5-naphtylene diisocyanate, 4,4′4″-triphenyl methane triisocyanate. m-isocyanate phenyl sulphonyl isocyanate, and p-isocyanate phenyl sulfonyl isocyanate; aliphatic polyisocyanates compounds such as ethylene diisocyanate, tetramethylene diisocyanate, hexamethylene diisocyanate (HDI), dodecamethylene diisocyanate, 1,6,11-undecane triisocyanate, 2,2,4-trimethyl hexamethylene diisocyanate, lysine diisocyanate, 2,6-diisocyante methylcaproate, bis(2-isocyanate ethyl)fumarate, bis(2-isocyanateethyl)carbonate, and 2-isocyanate ethyl-2,6-diisocyanate hexanoate; and alicyclic polyisocyanate compounds such as isophorone diisocyante (IPDI), 4,4′-dicyclohexyl methane diisocyanate (hydrogenated MDI), cyclohexylene diisocyante, methylcyclohexylene diisocyanate (hydrogenated TDI), bis(2-isocyanateethyl)-4-dichlorohexene-1,2-dicarboxylate, 2,5-norbornane diisocyante, and 2,6-norbonane diisocyante. These can be used alone or in combination.

Of these, aliphatic polyisocyanate compounds and alicyclic polyisocyanate compounds are preferable, alicyclic polyisocyanate compounds are more preferable, and isophorone diisocyanate and 4,4′-dicyclohexylmethane diisocyanate are particularly preferable.

Di- or Higher Valent Polyamine

Specific examples of the di- or higher polyamine include, but are not limited to, diamines such as ethylene diamine, 1,2-propane diamine, 1,6-hexamethylene diamine, piperazine, 2,5-dimethyl piperazine, isophorone diamine, 4,4′-dicyclohexyl methane diamine, and 1,4-cyclohexane diamine, polyamines such as diethylene triamine, dipropylene triamine, and triethylene tetramine, hydrazines, hydrazines such as N,N′ dimethyl hydrazine and 1,6-hexamethylene bis hydrazine, and dihydrazides such as succinic dihydrazide, adipic acid dihydrazide, glutaric acid dihydrazide, sebacic acid dihydrazide, and isophthalic acid dihydrazide.

Proportion of Urethane Group Contained

By increasing the proportion of the urethane group in the polyurethane segments in the crystalline polyester urethane resin and the non-crystalline polyurethane resin, the urethane resins in the ink of the present embodiment readily agglomerate due to hydrogen bond of the urethane resins, thereby forming a tough film having excellent strength and strechability, which leads to forming an image having excellent blocking resistance and friction resistance. One way to calculate the proportion of the urethane group is to use the following relationship 1. In the following relationship 1, the compound having a hydroxyl group refers to a compound having a hydroxyl group of the compounds as material for use in manufacturing the crystalline urethane resin.

Proportion of urethane group=(total number of moles of compound having hydroxyl group×molecular weight of urethane group/total mass of solid content of urethane resin)×100 Relationship 1

Cross-Linking Structure

The crystalline polyester urethane resin and the non-crystalline polyurethane resin preferably have a chemical cross linking derived from a covalent bond in their molecular structures in addition to the hydrogen bond, which is one of the original features of the resins. This chemical cross-linking attributable to a covalent bond enhances mechanical strength of the crystalline polyester urethane resin and the non-crystalline polyurethane resin so that images having excellent friction resistance and blocking resistance are formed.

Examples of the method of introducing chemical cross-linking include, but are not limited to, increasing the number of functional groups of the polymer polyol to more than 2, using a tri- or higher functional short-chain polyhydric alcohol, and using a tri- or higher polyisocyanate, and using a tri- or higher polyamines (triamine) having tri- or higher functional groups. Any of the methods of introducing a chemical cross-linking into a resin may be used alone or in combination. Any of the methods of introducing chemical cross-linking can be suitably used. Increasing the number of functional groups of the polymer polyol to more than 2 is particularly preferable in terms of cross-linking density. The number of the functional groups of the polymer polyol is preferably from more than 2 to 2.5 and more preferably from 2.02 to 2.15. The crystalline polyester urethane resin and the non-crystalline polyurethane resin in this range have excellent mechanical strength so that images having excellent friction resistance and blocking resistance are formed. The number of the functional groups of the polymer polyol can be increased than two due to the combinational use of a polymer polyol having two functional groups and a polymer polyol having three or more functional groups. The number of functional groups in the entire polymer polyol can be calculated according to the following relationship 2 when a polymer polyol having two functional groups and a polymer polyol having three or more functional groups are used in combination.

Number of functional groups of crystalline polyester polyol=2×a+b×(1−a) Relationship 2

In the relationship 2, “a” represents the mass ratio of the polymer polyol having two functional groups to the entire polymer polyol represented by the following relationship 3, “b” represents the number of functional groups of the polymer polyol having three or more functional groups, and “2” means the number of functional groups of the polymer polyol having two functional groups.

a=c/(c+d) Relationship 3

In the relationship 3, “c” represents the mass of the polymer polyol having two functional groups and “d” represents the mass of the polymer polyol having three or more functional groups. The polymer polyol having three or more functional groups is preferably a crystalline polymer polyol having three functional groups.

Coloring Material

The coloring material has no particular limitation. For example, pigments and dyes are suitable. Inorganic pigments or organic pigments can be used as the pigment. These can be used alone or in combination. Also, mixed crystals are usable as the pigments.

Examples of the pigments include, but are not limited to, black pigments, yellow pigments, magenta pigments, cyan pigments, white pigments, green pigments, orange pigments, and gloss or metallic pigments of gold, silver, and others.

Carbon black manufactured by known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigment include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of those pigments, pigments having good affinity with solvents are preferable. Also, hollow resin particles and hollow inorganic particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.1. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in the ink is preferably from 0.1 to 15 percent by mass and more preferably from 1 to 10 percent by mass to improve image density and have excellent fixability and discharging stability.

Ink can be obtained by dispersing a pigment. The pigment can be dispersed in ink by a method of introducing a hydrophilic functional group into a pigment to prepare a self-dispersible pigment, a method of coating the surface of a pigment with a resin followed by dispersion, or a method of using a dispersant to disperse a pigment, and other methods.

One way to prepare a self-dispersible pigment by introducing a hydrophilic functional group into a pigment is to add a functional group such as a sulfone group and carboxyl group to a pigment (e.g., carbon) to disperse the pigment in water.

One way to disperse a resin by coating the surface thereof is to encapsulate a pigment in a microcapsule to make it disperse in water. This can be referred to as a resin-coated pigment. In this case, all the pigments to be added to ink are not necessarily entirely coated with a resin. Pigments never or partially coated with a resin may be dispersed in the ink.

When a dispersant is used, a known dispersant having a small or large molecular weight represented by a surfactant is used.

It is possible to select an anionic surfactant, a cationic surfactant, a nonionic surfactant, an amphoteric surfactant, or others depending on a pigment.

A nonionic surfactant (RT-100, manufactured by TAKEMOTO OIL & FAT CO., LTD.) and a formalin condensate of naphthalene sodium sulfonate are suitably used as the dispersant.

Those can be used alone or in combination.

Organic Solvent

The organic solvent is not particularly limited and water-soluble organic solvents can be used. Examples include, but are not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of polyolhydric alcohols include, but are not limited to, ethylene glycol, diethylene glycol, 1,2-propanediol, 1,3-propanediol, 1,2-butanediol, 1,3-butanediol, 1,4-butane diol, 2,3-butanediol, 3-methyl-1,3-butanediol, triethylene glycol, polyethylene glycol, polypropylene glycol, 1,2-pentanediol, 1,3-pentanediol, 1,4-pentanediol 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol.

Specific examples of the polyhydric alcohol ethers include, but are not limited to, ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

Specific examples of the polyhydric alcohol aryl ethers include, but are not limited to, ethylene glycol monophenyl ether and ethylene glycol monobenzyl ether.

Specific examples of nitrogen-containing heterocyclic compounds include, but are not limited to, 2-pyrrolidone, N-methyl-2-pyrrolidone, N-hydroxyethyl-2-pyrrolidone, 1,3-dimethyl-2-imidazoline, ε-caprolactam, and γ-butylolactone.

Specific examples of the amide include, but are not limited to, formamide, N-methylformamide, N,N-dimethylformamide, 3-methoxy-N,N-dimethyl propionamide, and 3-butoxy-N,N-dimethyl propionamide.

Specific examples of amines include, but are not limited to, monoethanolamine, diethanolamine, and triethylamine.

Specific examples of the sulfur-containing compounds include, but are not limited to, dimethyl sulphoxide, sulfolane, and thiodiethanol.

Specific examples of the other organic solvents include, but are not limited to, propylene carbonate and ethylene carbonate.

It is preferable to use an organic solvent having a boiling point of 250 or lower degrees C., which serves as a humectant and imparts a good drying property at the same time.

Polyol compounds having eight or more carbon atoms and glycol ether compounds are also suitably used as the organic solvent.

Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyhydric alcohol alkylethers such as ethyleneglycol monoethylether, ethyleneglycol monobutylether, diethyleneglycol monomethylether, diethyleneglycol monoethylether, diethyleneglycol monobutylether, tetraethyleneglycol monomethylether, and propyleneglycol monoethylether and polyhydric alsochol arylethers such as ethyleneglycol monophenylether and ethyleneglycol monobenzylether.

The polyhydric alcohol or polyol compounds having eight or more carbon atoms and glycolether compounds enhance permeability of ink for paper used as a recording medium.

The proportion of the organic solvent of the ink has no particular limit and can be suitably selected to suit to a particular application.

In terms of drying property and discharging reliability of ink, the proportion is preferably from 10 to 60 percent by mass and more preferably from 20 to 60 percent by mass.

Water

The proportion of water in the ink is not particularly limited and can be suitably selected to suit to a particular application. In terms of the drying and discharging reliability of the ink, the proportion is preferably from 10 to 90 percent by mass and more preferably from 20 to 60 percent by mass of the total amount of the ink.

Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. In particular, silicone-based surfactants which do not decompose even at a high pH are preferable. Specific examples of the silicone-based surfactant include, but are not limited to, side-chain modified polydimethyl siloxane, both-terminal modified polydimethyl siloxane, one-terminal-modified polydimethyl siloxane, and side chain both-terminal modified polydimethyl siloxane. Silicone-based surfactants having a polyoxyethylene group or polyoxyethylene polyoxypropylene group as the modification group are particularly preferable because these demonstrate good properties as aqueous surfactants. It is possible to use a polyether-modified silicone-based surfactant as the silicone-based surfactant. A specific example is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid. Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application. Specific examples include, but are not limited to, side-chain-modified polydimethyl siloxane, both distal-end-modified polydimethyl siloxane, one-distal-end-modified polydimethyl siloxane, and side-chain-both-distal-end-modified polydimethyl siloxane. In particular, a polyether-modified silicone-based surfactant having a polyoxyethylene group or a polyoxyethylene polyoxypropylene group is particularly preferable because such a surfactant demonstrates good property as an aqueous surfactant.

Such surfactants can be synthesized or commercially procured. Products are available from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

The polyether-modified silicon-based surfactant has no particular limit and can be suitably selected to suit to a particular application. For example, a compound is usable in which the polyalkylene oxide structure represented by the following Chemical formula S-1 is introduced into the side chain of the Si site of dimethyl polysiloxane.

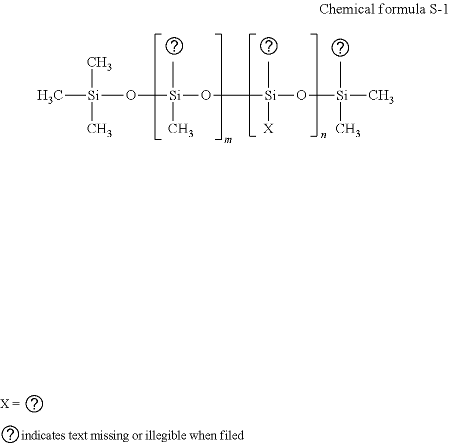

In Chemical formula S-1, “m”, “n”, “a”, and “b” each, respectively independently represent integers, R represents an alkylene group, and R′ represents an alkyl group.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Momentive Performance Materials Inc.).

A compound in which the number of carbon atoms replaced with fluorine atoms is from 2 to 16 is preferable and, from 4 to 16, more preferable, as the fluorochemical surfactant.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain. Of these, polyoxyalkylene ether polymer compounds having a perfluoroalkyl ether group in the side chain thereof are preferable because these polymer compounds do not easily foam and the fluorosurfactant represented by the following Chemical formula F-1 or Chemical formula F-2 is more preferable.

CF₂CF₂(CF₂CH₂)ₘ—CH₂CH₂O(CH₂CH₂O)ₙH Chemical formula F-1

In the Chemical formula F-1, “m” is preferably 0 or an integer of from 1 to 10 and “n” is preferably 0 or an integer of from 1 to 40.

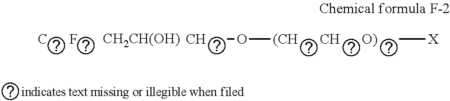

In the compound represented by the chemical formula F-2, Y represents H or CₘF₂ₘ₊₁, where n represents an integer of from 1 to 6, or CH₂CH(OH)CH₂—CₘF₂ₘ₊₁, where m represents an integer of from 4 to 6, or CₚH₂ₚ₊₁, where p is an integer of from 1 to 19. “n” represents an integer of from 1 to 6. “a” represents an integer of from 4 to 14.

The fluorochemical surfactant is commercially available. Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

The proportion of the surfactant in ink is not particularly limited and can be suitably selected to suit to a particular application. It is preferably from 0.001 to 5 percent by mass and more preferably from 0.05 to 5 percent by mass of the total amount of the ink in terms of enhancement of wettability and discharging stability and improvement on image quality.

Defoaming Agent

The defoaming agent has no particular limit and examples thereof include, but are not limited to silicon-based defoaming agents, polyether-based defoaming agents, and aliphatic acid ester-based defoaming agents. These can be used alone or in combination. Of these, silicone-based defoaming agents are preferable in terms of the effect of foam breaking.

Preservatives and Fungicides

The preservatives and fungicides are not particularly limited. A specific example is 1,2-benzisothiazoline-3-one.

Corrosion Inhibitor

The corrosion inhibitor has no particular limitation. Examples are acid sulfites and sodium thiosulfates.

pH Regulator

The pH regulator has no particular limit as long as it can control pH to be not lower than 7. Specific examples include, but are not limited to, amines such as diethanol amine and triethanol amine.

Method of Manufacturing Ink

The ink can be manufactured by dispersing or dissolving water, a coloring material, a resin, and other components in an aqueous medium followed by stirring and mixing. A device such as a sand mill, homogenizer, ball mill, paint shaker, ultrasonic dispersion, or others can be used for the dispersion. A stirrer using a normal stirring blade, a magnetic stirrer, a high performance disperser can be used for the mixing and stirring.

Recording Medium

The recording medium is not particularly limited. Media such as plain paper, gloss paper, special paper, and cloth are usable. Non-permeable substrates are preferable. If the recording medium is a non-permeable substrate, the use of the ink of the present embodiment is all the more effective because scratch resistance of an image formed with an ink tends to be inferior.

The non-permeable substrate has a surface with poor moisture permeability, absorbency, and/or adsorption and includes a substrate having many hollow spaces inside that are not open to the outside. To be more quantitative, the substrate has a water-absorbency of 10 mL/m² or less between the initiation of contact and 30 msec^{1/2} later according to Bristow's method.

Specific examples of the non-permeable substrates include, but are not limited to, vinyl chloride films, polypropylene films, polyethylene terephthalate films, nylon films, and synthetic paper.

Specific examples of the polypropylene film include, but are not limited to, P-2002, P-2161, and P-4166, all manufactured by TOYOBO CO., LTD., PA-20, PA-30, and PA-20W, all manufactured by SunTox Co., Ltd., FOA, FOS, and FOR, all manufactured by FUTAMURA CHEMICAL CO., LTD.

Specific examples of the polyethylene terephthalate film include, but are not limited to, E-5100 and E-5102, both manufactured by TOYOBO CO., LTD., P60 and P375, both manufactured by Toray Industries, Inc., and G2, G2P2, K, and SL, all manufactured by Teijin Dupont Film Japan Limited.

Specific examples of the nylon film include, but are not limited to, Harden films N-1100, N-1102, and N-1200, all manufactured by TOYOBO CO., LTD. and ON, NX, MS, and NK, all manufactured by UNITIKA LTD.

Specific examples of the synthetic paper include, but are not limited, to, FPU130, FPU200, FPU250, and VJFP120, all manufactured by Yupo Corporation.

Recorded Matter

The recorded matter has a recording medium and a print layer formed with the ink of the present embodiment on the recording medium. The printing layer contains the above-described coloring material and polymer because it is formed by applying and drying the ink of the present embodiment.

Ink Accommodating Container

The ink accommodating container includes an ink accommodating unit that contains the ink of the present embodiment and other optional suitably-selected members.

The ink accommodating container is not particularly limited. Any form, any structure, any size, and any material can be suitably selected to suit to a particular application. For example, a container having an ink accommodating unit made of aluminum laminate film, a resin film, or other substances is suitable.

Recording Device and Recording Method

The ink of the present embodiment can be suitably applied to various recording devices employing an inkjet recording method, such as printers, facsimile machines, photocopiers, multifunction peripherals (serving as a printer, a facsimile machine, and a photocopier), and solid freeform fabrication devices such as 3D printers and additive manufacturing devices.

The recording device and the recording method respectively represent a device capable of discharging ink, various processing fluids, and other liquids to a recording medium and a method of conducting recording on the recording medium utilizing the device. The recording medium means an article to which ink or various processing fluids can be temporarily or permanently attached.

The recording device may further optionally include a device relating to feeding, conveying, and ejecting a recording medium and other devices such as a pre-processing device and a post-processing device in addition to the head portion that discharges the ink.

The recording device and the recording method may further optionally include a heater for use in the heating process and a drier for use in the drying process. For example, the heating device and the drying device include devices including heating and drying the print surface of a recording medium and the opposite surface thereof. The heating device and the drying device are not particularly limited. For example, a fan heater and an infra-red heater can be used. Heating and drying can be conducted before, in the middle of, or after printing.

In addition, the recording device and the recording method are not limited to those producing meaningful visible images such as texts and figures with ink. For example, the recording method and the recording device capable of producing patterns like geometric design and 3D images are included.

In addition, the recording device includes both a serial type device in which the liquid discharging head is caused to move and a line type device in which the liquid discharging head is not moved, unless otherwise specified.

Furthermore, this recording device includes the desktop type, a device capable of printing images on a wide recording medium such as A0, and a continuous printer capable of using continuous paper rolled up in a roll form as recording media.

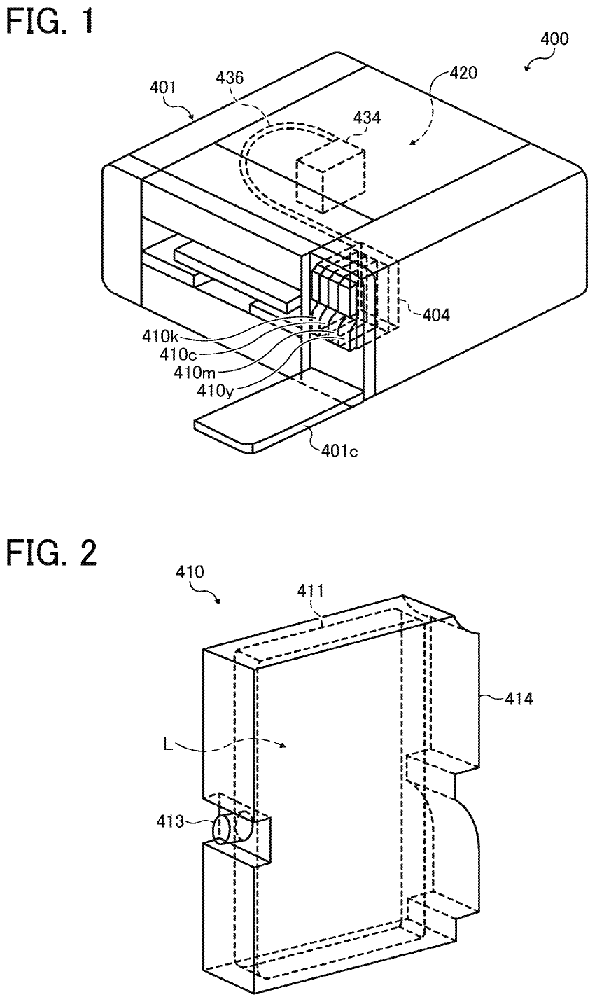

The recording (print) device is described using an example with reference to FIG. 1 and FIG. 2. FIG. 1 is a diagram illustrating a perspective view of the recording device. FIG. 2 is a diagram illustrating a perspective view of a tank. An image forming apparatus 400 as an embodiment of the recording device is a serial type image forming apparatus. A mechanical unit 420 is disposed in an exterior 401 of the image forming apparatus 400. Each ink accommodating unit (ink container) 411 of each tank 410 (410k, 410c, 410m, and 410y) for each color of black (K), cyan (C), magenta (M), and yellow (Y) is made of a packaging member such as aluminum laminate film. The ink accommodating unit 411 is housed in, for example, a plastic container housing unit 414 and L represents liquid contained in the ink accommodating unit 411. As a result, the tank 410 is used as an ink cartridge of each color.

A cartridge holder 404 is disposed on the rear side of the opening when a cover 401c is opened. The cartridge holder 404 is detachably attached to the tank 410. In this configuration, each ink discharging outlet 413 of the tank 410 communicates with a discharging head 434 for each color via a supplying tube 436 for each color and the ink can be discharged from the discharging head 434 to a recording medium.

Notably, the ink is applicable not only to the inkjet recording but can be widely applied in other methods. Specific examples of such methods other than the inkjet recording include, but are not limited to, blade coating methods, gravure coating methods, bar coating methods, roll coating methods, dip coating methods, curtain coating methods, slide coating methods, die coating methods, and spray coating methods.

Field of Application

The usage of the ink of the present embodiment is not particularly limited and can be suitably selected to suit to a particular application. For example, the ink can be used for printed matter, a paint, a coating material, and foundation. The ink can be used to produce two-dimensional text and images and furthermore used as a material for solid fabrication for manufacturing a solid fabrication object (or solid freeform fabrication object).

The solid fabrication apparatus to fabricate a solid fabrication object can be any known device with no particular limit. For example, the apparatus includes a container, supplying device, discharging device, drier of ink, and others. The solid fabrication object includes an object manufactured by repetitively coating ink. In addition, the solid fabrication object includes a mold-processed product manufactured by processing a structure having a substrate such as a recording medium to which the ink is applied. The mold-processed product is manufactured from recorded matter or a structure having a sheet-like form and film-like form by, for example, heating drawing or punching. The mold-processed product is suitably used to produce items surface-decorated after molding such as gauges or operation panels of vehicles, office machines, electric and electronic devices, and cameras.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. In the following description, “parts” means “parts by mass” unless otherwise specified, and “percent” means “percent by mass” unless otherwise specified.

First, the methods of analyzing properties in Manufacturing Examples and Preparation Examples are described.

Molecular Weight

Device: GPC (manufactured by TOSOH CORPORATION, detector: RI, measuring temperature: 40 degrees C.

Mobile phase: Tetrahydrofuran, flow rate: 0.45 mL/min.

The number average molecular weight (Mn), weight average molecular weight (Mw), and molecular weight distribution (Mw/Mn) are each measured by gel permeation chromatography (GPC) using a calibration curve prepared based on a polystyrene sample having a known molecular weight as a reference. The column was composed of those connected in serial, each having an exclusion limit of 60,000, 20,000, and 10,000.

Glass Transition Temperature Tg, Melting Point Tm, and Crystallization Temperature Tc

Four grams of the liquid resin dispersion (resin emulsion) or ink was placed in a container, evenly spread therein, and dried at 70 degrees C. for one hour and thereafter at 120 degrees C. for one minute to obtain dry matter of a measuring sample.

The measuring sample was analyzed under the following conditions to determine its thermal properties using a differential scanning calorimeter (DSC) (Q2000, manufactured by TA Instruments). Specifically, they were measured as follows:

Measuring Conditions
Sample container: Aluminum sample pan (with a lid)
Quantity of sample: 5 mg
Reference: Aluminum sample pan (empty container)
Atmosphere: nitrogen (rate of flow: 50 ml/min)
Starting Temperature: −80 degrees C.
Temperature rising rate: 10 degrees C./min
Ending temperature: 130 degrees C.
Holding time: one minute
Temperature falling rate: 10 degrees C./min
Ending temperature: −80° C.
Holding time:5 minutes
Temperature rising rate: 10 degrees C./min;
Ending temperature: 130 degrees C.

A graph of the heat of reaction and temperature was plotted based on the measuring results.

The characteristic point of inflection present in the first temperature rising was determined as the Tg. In addition, the value obtained by the midpoint method from the DSC curve was used as the Tg.

The temperature of the melting peak (endothermic peak) present in the second temperature rising was determined as the Tm. The amount of melting heat was calculated by defining the endotherm in the temperature rising as melting region.

The temperature of the peak of the crystallization (exothermic peak) in the temperature falling was defined as the crystallization peak temperature. The amount of crystallization heat was calculated by defining the exotherm in the temperature falling as crystallization region.

Volume Average Particle Diameter (Mean Volume Diameter)

The mean volume diameter was measured by a dynamic light scattering method using a zeta potential-particle size measuring system (ELSZ-1000, manufactured by OTSUKA ELECTRONICS Co., LTD.).

First, 0.2 g of a liquid resin dispersion (resin emulsion) was weighed, and thereafter diluted by a factor of 100 with deionized water. Some of the resulting solution was loaded in a quartz cell, which was placed in a sample holder. Thereafter, the resin was measured under the conditions of temperature of 25 degrees C., dust cut (5 times, Upper: 5, Lower: 100), and number of measuring mean volume diameter: 70 and the mean volume diameter was obtained.

Manufacturing Example of Crystalline Polyester Urethane Resin

First, 1,4-butanediol as a diol and sebacic acid as a dicarboxylic acid were placed in a 5 L four-necked flask equipped with a nitrogen introducing tube, a dehydrating tube, a stirrer, and a thermocouple to achieve an OH to COOH molar ratio of diol to dicarboxylic acid of 1.40 to 1. Subsequent to sufficient replacement with nitrogen gas in the reaction vessel, 300 ppm (based on the monomer) of titanium tetraisopropoxide was added, and the temperature was raised to 200 degrees C. in about four hours in a nitrogen atmosphere. Thereafter, the temperature was raised to 230 degrees C. over two hours to continue the reaction until no effluent was produced. Thereafter, the resulting substance was allowed to react for one hour under a reduced pressure of from 10 to 30 mm Hg to obtain a crystalline polyester polyol.

The resulting resin had an acid value (AV) of 2.3 mg KOH/g, a hydroxyl value (OHV) of 86 mg KOH/g, a melting point (Tm) of 62.1 degrees C., a crystallization temperature (Tc) of 45.9 degrees C., a number average molecular weight (Mn) of 2,300, and a weight average molecular weight (Mw) of 3,900.

A total of 50 g of crystalline polyester polyol synthesized as polymer polyol, 2.8 g of 2,2-bis(hydroxymethyl)propionic acid, and 19.3 g of 4,4′-dicyclohexylmethane diisocyanate, 3 0 2.1 g of triethylamine, and 39 g of methylethyl ketone as an organic solvent were placed in a 1 L separable flask equipped with a stirrer, a thermometer, and a reflux tube while nitrogen was being introduced. A single drop of a catalyst (tin(II)di(2-ethylhexanoate)) was added and the temperature was then raised to 60 degrees C. followed by refluxing for two hours. The temperature was then lowered to and kept at 40 degrees C. After percent of NCO present in the system was checked, 138 g of water was slowly added to form fine particles while the resin solution was stirred at 500 rpm followed by heating and stirring for 30 minutes. Thereafter, 0.33 g of diethylenetriamine was added followed by heating and stirring for one hour. The system was purged of methylethyl ketone to obtain a crystalline polyester urethane resin emulsion having a solid content of 30 percent by mass and a cumulative volume particle diameter (D50) of 34 nm.

The dry matter obtained by drying the resin emulsion had a melting point (amount of melting heat) of 46 degrees C. (24 J/g) and a crystallization temperature (amount of crystallization heat) of −15 degrees C. (11 J/g).

Manufacturing Example of Non-crystalline Polyurethane Resin

An adduct of bisphenol A with EO as a diol and isophthalic acid as a dicarboxylic acid were placed in a 2-L four-necked flask equipped with a nitrogen introducing tube, a dehydrating tube, a stirrer, and a thermocouple to achieve an OH to COOH ratio of diol to dicarboxylic acid of 1.35 to 1. Subsequent to sufficient replacement with nitrogen gas in the reaction vessel, 300 ppm (based on the monomer) of titanium tetraisopropoxide was added, and the temperature was raised to 200 degrees C. in about four hours in a nitrogen atmosphere. Thereafter, the temperature was raised to 230 degrees C. over two hours to continue the reaction until no effluent was produced. Thereafter, the resulting substance was allowed to react for four hours under a reduced pressure of from 10 to 30 mm Hg to obtain a non-crystalline polyester polyol.

The thus-obtained resin had an AV of 1.6 mg KOH/g, an OHV of 84 mg KOH/g, a Tg of 45.4 degrees C., and an Mw of 3,400.

A total of 140 g of the non-crystalline polyester polyol synthesized as a polymer polyol, 10.18 g of 2,2-bis(hydroxymethyl)propionic acid, and 64 g of 4,4′-dicyclohexylmethane diisocyanate, 6.5 g of triethylamine, and 115 g of acetone as an organic solvent were placed in a 1 L separable flask equipped with a stirrer, a thermometer, and a reflux tube while nitrogen was being introduced. A single droplet of a catalyst (tin(II)di(2-ethylhexanoate)) was added and the temperature was then raised to 60 degrees C. followed by refluxing for two hours. The resulting non-crystalline polyurethane resin solution had an NCO percent of 1.6 percent at a solid content of 65 percent and an Mw of 800. After the temperature of the resin solution was raised to 40 degrees C., 410 g of water was slowly added to form fine particles while the resin solution was stirred at 500 rpm followed by heating and stirring for 30 minutes. Thereafter, 4.25 g of diethylenetriamine was added followed by heating and stirring for two hours. The system was purged of acetone to obtain a non-crystalline polyurethane resin emulsion having a solid content of 30 percent by mass and a D50 of 170 nm.

The dry matter obtained by drying the resulting resin emulsion had a Tg of 70.7 degrees C.

Manufacturing Example of Cyan Pigment of Polymer Emulsion Type

A flask equipped with a mechanical stirrer, a thermometer, a nitrogen gas introducing tube, a reflux tube, and a dripping funnel was sufficiently replaced with nitrogen gas and thereafter 11.2 g of styrene, 2.8 g of acrylic acid, 12.0 g of lauryl methacrylate, 4.0 g of polyethlene glycol methacrylate, 4.0 g of styrene macromer (AS-6, manufactured by TOA GOSEI CO., LTD.), and 0.4 g of mercapto ethanol were charged and mixed in the flask followed by heating the system to 65 degrees C.

Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer (AS-6, manufactured by TOA GOSEI CO., LTD.), 3.6 g of mercapto ethanol, 2.4 g of azobismethyl valeronitrile, and 18 g of methylethyl ketone was added dropwise to the flask over two and a half hours.

Subsequently, another liquid mixture of 0.8 g of azobismethyl valeronitrile and 18 g of methyl ethyl ketone was added dropwise to the flask in half an hour. After one-hour aging at 65 degrees C., 0.8 g of azobismethyl valeronitrile was added followed by aging for another hour. After completion of the reaction, 364 g of methylethyl ketone was added to the flask to prepare 800 g of a polymer solution at a concentration of 50 percent by mass.

Next, 46 g of the resulting polymer solution, 33 g of C.I.Pigment Blue 15:3 (manufactured by Dainichiseika Color & Chemicals Mfg. Co., Ltd.), 13.6 g of aqueous solution of potassium hydroxide at 1 mol/L, 20 g of methyl ethyl ketone, and 13.6 g of deionized water were sufficiently stirred followed by kneading using a roll mill. The resulting paste was charged into 200 g of pure water followed by sufficient stirring. After methylethyl ketone and water were distilled away using an evaporator, glycerin was added to prepare a cyan pigment of polymer emulsion type containing a pigment at 10.9 percent by mass, a resin at 7.5 percent by mass (solid concentration of 18.4 percent by mass), and glycerin at 9.1 percent by mass.

Preparation Example of Ink

### Example 1

An ink was prepared based on the following formulation. After the pH was controlled, the ink was filtered with a membrane filter having an average pore diameter of 5 μm to prepare ink 1. The mass ratio of the crystalline polyester urethane resin to the non-crystalline polyurethane resin in the ink 1 is 10 to 90. The dry matter obtained by drying the ink 1 had a melting point (amount of melting heat) of 45 degrees C. (0.8 J/g) and a crystallization temperature (amount of crystallization heat) of −3 degrees C. (0.5 J/g).
Cyan pigment of polymer emulsion type: 22.91 percent by mass
Crystalline polyester urethane resin emulsion: 1.30 percent by mass
Non-crystalline polyurethane resin emulsion: 11.70 percent by mass
Diethylene glycol monoethyl ether: 15.0 percent by mass
Propylene glycol: 14.0 percent by mass
3-methoxy-N,N-dimethyl propionamide: 5.0 percent by mass
2-ethyl-1,3-hexane diol: 2.0 percent by mass
Silicone-based surfactant (L-7002, manufactured by Dow Coming Toray Co., Ltd.): 1.0 percent by mass
Fluorochemical surfactant (MegaFace F-444, manufactured by DIC Corporation): 1.0 percent by mass
Preservatives and fungicides PROXEL LV (manufactured by AVECIA GROUP): 0.05 percent by mass
pH regulator (triethanolamine): 0.3 percent by mass
Water: balance (total: 100 percent by mass)

### Example 2

Ink 2 was prepared in the same manner as in Example 1 except that the mass ratio of the crystalline polyester urethane resin to the non-crystalline polyurethane resin was changed 2 0 to 20:80 without changing the total amount of the crystalline polyester urethane resin and the non-crystalline polyurethane resin. The dry matter obtained by drying the ink 2 had a melting point (amount of melting heat) of 45 degrees C. (1.2 J/g) and a crystallization temperature (amount of crystallization heat) of −5 degrees C. (0.7 J/g).

### Example 3

Ink 3 was prepared in the same manner as in Example 1 except that the mass ratio of the crystalline polyester urethane resin to the non-crystalline polyurethane resin was changed to 50 : 50 without changing the total amount of the crystalline polyester urethane resin and the non-crystalline polyurethane resin. The dry matter obtained by drying the ink 3 had a melting point (amount of melting heat) of 48 degrees C. (7.0 J/g) and a crystallization temperature (amount of crystallization heat) of −8 degrees C. (3.0 J/g).

### Example 4

Ink 4 was prepared in the same manner as in Example 1 except that the mass ratio of the crystalline polyester urethane resin to the non-crystalline polyurethane resin was changed to 80 : 20 without changing the total amount of the crystalline polyester urethane resin and the non-crystalline polyurethane resin. The dry matter obtained by drying the ink 4 had a melting point (amount of melting heat) of 45 degrees C. (10.2 J/g) and a crystallization temperature (amount of crystallization heat) of −10 degrees C. (6.2 J/g).

### Example 5

Ink 5 was prepared in the same manner as in Example 1 except that the mass ratio of the crystalline polyester urethane resin to the non-crystalline polyurethane resin was changed to 90 : 10 without changing the total amount of the crystalline polyester urethane resin and the non-crystalline polyurethane resin. The dry matter obtained by drying the ink 5 had a melting point (amount of melting heat) of 46 degrees C. (13.9 J/g) and a crystallization temperature (amount of crystallization heat) of −14 degrees C. (9.1 J/g).

### Comparative Example 1

Ink 6 was prepared in the same manner as in Example 1 except that the mass ratio of the crystalline polyester urethane resin to the non-crystalline polyurethane resin was changed to 0 : 100 without changing the total amount of the crystalline polyester urethane resin and the non-crystalline polyurethane resin. The dry matter obtained by drying the ink 6 had a glass transition temperature of 68 degrees C.

### Comparative Example 2

Ink 7 was prepared in the same manner as in Example 1 except that the mass ratio of the crystalline polyester urethane resin to the non-crystalline polyurethane resin was changed 2 0 to 100 : 0 without changing the total amount of the crystalline polyester urethane resin and the non-crystalline polyurethane resin. The dry matter obtained by drying the ink 7 had a melting point (amount of melting heat) of 46 degrees C. (17 J/g) and a crystallization temperature (amount of crystallization heat) of −15 degrees C. (10 J/g).

Each prepared ink was evaluated on fixability, storage stability, and discharging recovery in the following manner. The measuring results are shown in Tables 8 to 1.

Fixability

An inkjet printer (IPSiO GXe5500, manufactured by Ricoh Co., Ltd.) was filled with the prepared ink and a solid image of 1,200 dpi×1,200 dpi was printed on polypropylene-based synthetic paper (FPU-130, manufactured by YUPO CORPORATION) heated to 50 degrees C.) followed by heat drying on a hot plate at 70 degrees C. for three minutes.

The solid image formed on the recording medium was subjected to cross cut testing using an adhesive tap (123LW-50, manufactured by Nichiban Co., Ltd.) to evaluate fixability to a recording medium. Specifically, the solid image was cut into 100 grids of 1 mm×1 mm and an adhesive tape was attached thereto. The adhesive tape was quickly detached. The number of the grids completely remaining without damage was counted and rated according to the following evaluation criteria. Grade C or above is determined as usable for practical purpose.

Evaluation Criteria
A: Number of remaining grids was 100
B: Number of remaining grids was from 50 to less than 100
C: Number of remaining grids was 1 to less than 50
D: Number of remaining grids was 0

Storage Stability

Each prepared ink was loaded in an ink container and stored at 70 degrees C. for two weeks and viscosity of the ink was measured before and after the storage. The viscosity was measured at 25 degrees C. at 50 rotations using a viscometer (RE80L, manufactured by TOKI SANGYO CO., LTD.). The viscosity change ratio of the ink was calculated according to the following relationship and storage stability thereof was evaluated based on the viscosity change ratio according to the following criteria. Grade C or above is determined as usable for practical purpose.

Viscosity change ratio (percent)=(viscosity after storage−viscosity before storage)/(viscosity before storage)×100

Evaluation Criteria
A: Viscosity change ratio within the range of from −5 percent to +5 percent
B: Viscosity change ratio within the range of from −8 percent to less than -5 percent and more than 5 percent to 8 percent
C: Viscosity change ratio within the range of from −10 percent to less than −8 percent and more than 8 percent to 10 percent.
A: Viscosity change ratio less than −10 percent and more than 10 percent

Discharging Recovery

An inkjet printer (IPSiO GXe5000, manufactured by Ricoh Co., Ltd.) was filled with each of the inks of Examples and Comparative Examples and left undone for three hours in an HL environment (32±0.5 degrees C., 15±5 percent RH). A nozzle check pattern was printed and it was confirmed that the check pattern was free of discharging failures such as dot omission or discharging deviation in the air. Further, it was allowed to rest as was (decapped state) for six days. After the resting, a nozzle check pattern with a solid printing portion was printed on high-quality paper My Paper (manufactured by Ricoh Co., Ltd.) with a basis weight of 69.6 g/m², a size degree of 23.2 seconds, and air permeability of 21.0 seconds to check whether dot omission and discharging deviation in the air were present. If the dot omission or discharging deviation was present in the nozzle check pattern, the printer nozzle was restored by cleaning. The total number of the cleaning was counted and evaluated. Based on the obtained total number of cleaning, the discharging recovery of each ink was evaluated according to the following evaluation criteria. The recording medium was determined as usable for practical purpose when graded C or above after being left undone for six days.

Evaluation Criteria

A: No cleaning

B: Cleaning once

D: Cleaning twice

D: Cleaning three to five times

E: Cleaning five times or more

TABLE 1

| | Ex- | Ex- | Ex- | Ex- | Ex- | Compar- | Compar- |
|---|---|---|---|---|---|---|---|
| | am- | am- | am- | am- | am- | ative Ex- | ative Ex- |
| | ple 1 | ple 2 | ple 3 | ple 4 | ple 5 | ample 1 | ample 2 |
| Ink | 1 | 2 | 3 | 4 | 5 | 6 | 7 |
| Attachability | C | B | B | B | A | D | A |
| Storage | A | B | B | B | C | A | D |
| stability | | | | | | | |
| Discharging | B | B | B | B | C | B | E |
| recovery | | | | | | | |

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An ink comprising:
a coloring material;
a crystalline polyester urethane resin; and
a non-crystalline polyurethane resin,
wherein dry matter of the ink has a differential scanning calorimetry curve having a melting peak temperature (Tm) of from 30 to 100 degrees C. as measured with a differential scanning calorimeter.

2. The ink according to claim 1, wherein the melting peak is a peak corresponding to the crystalline polyester resin.

3. The ink according to claim 1, wherein a mass ratio of the crystalline polyester resin to the non-crystalline polyurethane resin is from 15:85 to 85:15.

4. The ink according to claim 1, wherein the crystalline polyester urethane resin has a structural unit derived from an aliphatic diol and a structural unit derived from an aliphatic dicarboxylic acid.

5. The ink according to claim 1, wherein the differential scanning calorimetry curve has a crystallization peak having a crystallization heat of from 1.0 to 12.0 J/g.

6. The ink according to claim 1, wherein the crystalline polyester urethane resin and the non-crystalline polyurethane resin have a carboxyl group and an acid value of from 10 to 40 mgKOH/g.

7. The ink according to claim 1, wherein the crystalline polyester urethane resin and the non-crystalline polyurethane resin have a urea bond derived from a di- or higher valent polyamine.

8. An ink accommodating container according to claim 1, comprising:
a container; and
the ink of claim 1 contained in the container.

9. A recording device comprising:
a container;
the ink of claim 1 contained in the container; and
a discharging device configured to discharge the ink accommodated in the container.

10. A recording method comprising:
discharging the ink of claim 1.

11. Recorded matter comprising:
a recording medium; and
a print layer formed on the recording medium and containing a coloring material, a crystalline polyester urethane resin, and a non-crystalline polyurethane resin,
wherein the print layer has a differential scanning calorimetry curve having a melting peak temperature (Tm) of from 30 to 100 degrees C. as measured with a differential scanning calorimeter (DSC).
